(19) United States
(12) Patent Application Publication
(10) Pub. No.: US 2026/0233150 A1
(43) Pub. Date: Aug. 13, 2026

(54) METHOD FOR OPERATING A DIRECT AIR CAPTURE PROCESS USING A LARGE-SCALE ARRAY

(71) Applicant: SHELL USA, INC, Houston, TX (US)

(72) Inventors: Sayee Prasaad BALAJI, Amsterdam (NL); Timothy Michael NISBET, Amsterdam (NL); Ghata Manishkumar NIRMAL, Bangalore North (IN)

(21) Appl. No.: 19/156,526

(22) PCT Filed: Feb. 5, 2024
(86) PCT No.: PCT/EP2024/052757

§ 371 Date: Aug. 14, 2025

(30) Foreign Application Priority Data
Feb. 17, 2023 (EP) 23157177.9

(51) Int. Cl. B01D 53/04

(52) U.S. Cl. CPC B01D 53/0446; B01D 2257/504

(57) ABSTRACT

Implementations of the disclosed subject matter provide a method for operating a direct air capture (DAC) process. The method may include an array comprising a plurality of DAC units, each unit may include at least one side inlet face and an outlet. The array may have a shape that is not a single line formation and may have upwind and downwind sides dependent on a direction of a wind stream in the surrounding atmosphere. An air feed stream may be received at the inlet faces and may have an average CO2 concentration of at least 300 ppmv for all atmospheric conditions. A CO2 depleted outlet stream may be provided at the outlets and may have a flow generated by a device. Multiple recirculation zones may be generated by a subset of DAC units, and each zone may have an inner and outer sections, and a recirculation flow.

### TECHNICAL FIELD OF THE INVENTION

The present invention relates to a direct air capture (DAC) process for capturing carbon dioxide (CO₂) from the atmosphere. More specifically the present invention relates to a process for capturing carbon dioxide (CO₂) from the atmosphere using a large direct air capture array.

### BACKGROUND

Direct air capture (DAC) of carbon dioxide from the air has been proposed as one way of addressing human induced climate change. Current estimates place global levels of carbon dioxide in the atmosphere at around 420 parts per million. This is expected to rise to around 900 parts per million by the end of the 21st century. Hence, DAC represents one of a range of technologies that can be employed to reduce the environmental impact of greenhouse gases like carbon dioxide and help the transition to a low carbon global economy.

An attractive option for direct air capture of CO₂ is a process by which CO₂ in the atmosphere is captured using a solid sorbent. Typical DAC systems take large quantities of air (or other conditioned gaseous atmosphere) which is pumped as a feedstream through a unit that contains a sorbent substance that removes the carbon dioxide from the feedstream. At the same time, it is important to avoid reprocessing of CO₂ depleted air, as this significantly decreases the CO₂ capture efficiency of the overall process.

In general, CO₂ can only reach a DAC process by two mechanisms: bulk movement of air by wind or dispersion of air. Dispersion calculations show that for large DAC arrays (e.g. 1 million tons CO₂ captured per year), typical array dimensions of up to several kilometers are needed. Under atmospherically stable/low wind conditions, significant CO₂ depletion occurs at the downwind side of the array, leading to reprocessing of CO₂ depleted air. This creates challenges to achieving maximum CO₂ capture efficiency. Some options would be to apply larger arrays (lower productivity) or accept poor performance for low wind, stable air conditions (a lower time averaged productivity); however, neither of these options are desirable because of overall lower productivity. Therefore, it is important to design a DAC process that can achieve maximum economic productivity of a large scale DAC array for all atmospheric conditions.

### BRIEF SUMMARY

According to an embodiment of the disclosed subject matter, a method for operating a direct air capture process may include an array including a plurality of direct air capture (DAC) units. Each DAC unit may include: at least one side inlet face, and an outlet located at the top of the DAC unit. The DAC units may be arranged in the array having an overall array shape that is not a single line formation. The array may have an upwind side and a downwind side dependent on a wind direction of a wind stream in the surrounding atmosphere. A wind stream may be received at the upwind side of the array and the wind stream may have a wind speed of 1.0 m/s or more. An air feed stream may be received at the plurality of side inlet faces, and the air feed stream may have an average CO₂ concentration of at least 300 ppmv for all atmospheric stability conditions. A CO₂ depleted outlet stream having a flow may be provided at each of the outlets, and the flow is generated by a device for increasing kinetic energy of the CO₂ depleted outlet stream. A plurality of recirculation zones may be generated. Each recirculation zone may be generated by a subset of DAC units within the array, the subset including a combination of DAC units located between the upwind and downwind sides of the array, and each recirculation zone may have an inner section, an outer section, and a recirculation flow.

Implementations of the disclosed subject matter provide a method for operating a direct air capture process using a large scale array. The disclosed subject matter allows for optimized array dimensions and reduced costs in the overall DAC process. Specifically, the disclosed subject matter allows for a DAC array to occupy less land area, while still meeting target productivity for all wind directions, wind speeds and atmospheric stability conditions. Further, the present invention results in reduced cost of interconnecting pipework systems. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a top view of a large scale direct air capture array according to an implementation of the disclosed subject matter.

FIG. 2 shows a side view of a DAC unit according to an implementation of the disclosed subject matter.

FIG. 3 shows a contour map of bulk air mixing zones increasing in the downwind direction across the array according to an implementation of the disclosed subject matter.

FIG. 4 shows a side view of an example air flow directions within a recirculation zone surrounding a DAC unit according to an implementation of the disclosed subject matter.

FIG. 5 shows a side view of an example air flow directions within a plurality of recirculation zones surrounding a plurality of DAC units according to an implementation of the disclosed subject matter.

FIG. 6 shows a top view of examples of polygonal and ellipsoidal array shapes according to an implementation of the disclosed subject matter.

FIG. 7 shows a top view of an example orthogonal arrangement of DAC units within an array according to an implementation of the disclosed subject matter.

FIG. 8 shows a top view of an example diagonal arrangement of DAC units within an array according to an implementation of the disclosed subject matter.

FIG. 9 shows a top view of the average distance X between the centers of adjacent DAC units according to an implementation of the disclosed subject matter.

### DETAILED DESCRIPTION

In general, an attractive option for direct air capture of CO₂ is a process by which CO₂ in the atmosphere is captured using a solid sorbent. Because of the low CO₂ concentration in air, very large amounts of air need to be processed in order to extract industrially interesting volumes of CO₂. Typical DAC systems take large quantities of air (or other conditioned gaseous atmosphere) which is pumped as a feedstream through a unit that contains a sorbent substance that removes the carbon dioxide from the feedstream. At the same time, it is important to avoid reprocessing of CO₂ depleted air, as this significantly decreases the CO₂ capture efficiency of the overall process. In general, CO₂ can only reach the DAC system by 2 mechanisms: bulk movement of air by wind or dispersion of air. Dispersion calculations show that for large DAC arrays (e.g. 1.8 mtpa), typical array dimensions of up to several kilometers are needed to prevent DAC units within the array located close to the downwind side of the array from ingesting CO₂ depleted air.

Because of the very low CO₂ concentration in ambient air (about 400 ppmv) very large volumes of air need to be processed in commercial DAC units. For example, for a 1786 kta plant with a productivity of 7 kg CO₂/(m3 sorbent·h) and a sorbent pressure drop of 100 Pa, a total frontal area of 84,000 m2 is required. It is impracticable to provide this frontal area in a single unit. Thus, large scale DAC processes are thus inevitably made up of an interconnected array of DAC units.

Further, commercial DAC arrays need to function adequately for all wind directions and all wind speeds in the surrounding atmosphere. For example, a DAC array may be arranged with a plurality of DAC units in a single line formation along an axis. In this comparative case, the linear shaped array will function efficiently when the wind direction is close to orthogonal to the axis of the array, but very inefficiently when the wind direction is close to parallel to the axis of the array. In this latter comparative case, reprocessing of CO₂ depleted air will occur, as lateral dispersion is not sufficient to replenish the airflow with CO₂ thereby resulting in undesirable inefficiency of the CO₂ capture process. Therefore, it is an important feature of the present invention that it avoids reingestion of CO₂ depleted air and maximizes the efficiency of the CO₂ capture process.

Under atmospherically stable/low wind conditions, significant CO₂ depletion occurs at the downwind side of the array. This creates challenges to achieving maximum CO₂ capture efficiency. Some options would be to apply larger arrays (lower productivity) or accept poor performance for low wind, stable air conditions (a lower time averaged productivity); however, neither of these options are desirable because of overall lower productivity and lower CO₂ capture efficiency. Therefore, it is important to design a DAC process that can achieve maximum economic productivity of a large-scale DAC array for all atmospheric conditions.

According to the present invention, it has been found that, for arrays of DAC units with a side-in/top-out air flow, air circulation patterns may be set up and reinforced to move in the direction of the downwind side of the array. An advantage of the presentation invention is that by reinforcing the air circulation patterns in the direction of the downwind side of the array, this results in a well-mixed zone extending up to a typical height of 100 m above the ground. This well-mixed zone is achieved by the present invention even under low wind, atmospherically stable air conditions. The mixing is therefore significantly enhanced compared to normal air dispersion. This means that reprocessing of CO₂ depleted air is minimized, and the array maintains productivity and maximum CO₂ capture efficiency for all wind and atmospheric conditions, another advantage of the disclosed subject matter.

According to the disclosed subject matter, the present invention is directed to a method for operating a direct air capture process including a configuration for an array of DAC units, such that recirculation zones are created by the cumulative action of the devices on the DAC modules for increasing kinetic energy of the CO₂ depleted outlet streams, and increasing in the downwind direction across the array. The device for increasing kinetic energy can be, for example, a fan, a compressor or an ejector. The present invention results in the significantly increased productivity (e.g., measured as CO₂ captured per unit land area per unit time) as compared to an array where these air mixing zones are not created. Specifically, for low wind, atmospherically stable air conditions, another advantage of the disclosed subject matter is that productivity is much higher than what can be achieved without creation of these bulk mixing zones.

According to an embodiment of the present invention, a method for operating a direct air capture process may include an array including a plurality of direct air capture (DAC) units. Each DAC unit may include at least one side inlet face, and an outlet located at the top of the DAC unit. In an embodiment, each DAC unit may have multiple side inlet faces for receiving an air feed stream.

The array of DAC units may have an overall shape. According to an embodiment, the DAC units may be arranged in the array having an overall array shape that is not a single line formation. For example, a single line formation may refer to a sequence of DAC units, each unit lined up along an axis (e.g., in front of or behind an adjacent unit) and creating an array having an overall shape of a single line. In this comparative case, the linear array (i.e., having a single line formation) will function efficiently when the wind direction is close to orthogonal to the axis of the array, but very inefficiently when the wind direction is close to parallel to the axis of the array. In this latter comparative case, reprocessing of CO₂ depleted air will occur, as lateral dispersion is not sufficient to replenish the airflow with CO₂ resulting in inefficiency of the CO₂ capture process. In an embodiment, the array may have an overall array shape of a polygonal or ellipsoidal form. For example, a polygon may be a square, rectangle, triangle, etc. For example, an ellipsoid may be any circular, rounded, or oval shape. Further, according to an embodiment, the DAC units within the array may be arranged in an orthogonal or diagonal pattern.

According to an embodiment, the array may have an upwind side and a downwind side dependent on a wind direction of a wind stream in the surrounding atmosphere. In general, upwind is known as the direction the wind is coming from whereas downwind refers to the direction away from the wind source. For example, if the wind is blowing from the northwest (blowing toward the southeast direction) then the upwind direction is toward the northwest and the downwind direction is toward the southeast. In an embodiment, an upwind side may be the side of the array at which the wind direction is blowing towards the array, whereas the downwind side may be the side of the array away from the wind direction.

In an embodiment, a wind stream may be received at the upwind side of the array and the wind stream may have a wind speed of 1.0 m/s or more. An air feed stream may be received at the plurality of side inlet faces, and the air feed stream may have an average CO₂ concentration of at least 300 ppmv for all atmospheric stability conditions. Atmospheric stability conditions are well known classifications and are commonly grouped as extremely unstable, moderately unstable, slightly unstable, neutral, slightly stable and moderately stable. See for example the book “Turbulent Diffusion in the Environment” by G. T. Csanady (1973), ISBN-13:978-90-277-0261-6. See Table 1 below reproduced from Csanaday (1973).

Particularly for neutral or stable atmospheric conditions and low wind speeds, insufficient amounts of CO₂ may reach the DAC units in an array—this may result in an lower productivity to be achieved by the array which is economically undesirable. The present invention addresses this problem by creating bulk air mixing zones which greatly enhance the vertical dispersion of air and hence bring more CO₂ to the DAC units. This allows construction of DAC arrays with significantly higher productivities and hence better economics.

TABLE 1
Pasquill stability categories taken from Csanady (1973)

| | | | | Night, mainly | |
|---|---|---|---|---|---|
| Surface wind | Insolation | | | overcast or ≥4/8 | ≤3/8 Low |
| speed, m s⁻¹ | Strong | Moderate | Slight | low cloud | cloud |
| 2 | A | A-B | B | — | — |
| 2-3 | A-B | B | C | E | F |
| 3-5 | B | B-C | C | D | E |
| 5-6 | C | C-D | D | D | D |
| 6 | C | D | D | D | D |

A—Extremely unstable, B—Moderately unstable, C—Slightly unstable D—Neutral, D—Slightly stable, F—Moderately stable.

A CO₂ depleted outlet stream having a flow may be provided at each of the outlets. The flow of the CO₂ depleted outlet stream may be generated by a device for increasing kinetic energy of the CO₂ depleted outlet stream. For example, a device for increasing kinetic energy may be a fan, compressor, and the like. According to an embodiment, the flow of the CO₂ depleted outlet stream may have a flow direction that is within 20° of vertical. In general, vertical refers to a point that is located at a 90° angle to a horizontal plane. For example, the flow direction of the CO₂ depleted outlet stream may be straight up from the outlet at the top of the DAC unit, or may be within 20° of vertical relative to straight up from the DAC outlet. In an embodiment, the the CO₂ depleted outlet stream may have a velocity between 5 and 15 m/s.

In an embodiment, the method for operating a direct air capture process as disclosed herein, may also include a plurality of recirculation zones. Each recirculation zone may be generated by a subset of DAC units within the array, the subset including a combination of DAC units located between the upwind and downwind side of the array. Further, each recirculation zone may have an inner section, an outer section, and a recirculation flow. In an embodiment, the recirculation flow within the inner section may be upward in direction. In another embodiment, the recirculation flow within the outer section may be downward in direction. Furthermore, each recirculation zone may have a height H. According to an embodiment, the height H of the recirculation zone may increase towards the downwind side within the subset of DAC units, and the height H may be at least 100 meters at the DAC unit located at the downwind side of the array within the subset. For example, the height of the recirculation zone at the upwind side within the subset of DAC units may be H=50 meters and the height of the recirculation zone at the DAC unit at the downwind side of the subset of DAC units may be H=125 meters.

In an embodiment, each DAC unit may have a center point, and the DAC units may be arranged with a spacing X, where X may be the average distance between the center points of each of the DAC units within the array.

According to an embodiment, the array may include N number of DAC units. In this case, Y may be the capture capacity in tons per annum CO₂ of a single DAC unit and Z may be the ratio of the spacing X and the square root of the capture capacity of a single DAC unit Y, where Z may be between 0.5 and 2.0. The equation below shows how to determine Y and Z according to the disclosed subject matter.

$$wherein ; Y = \frac{Capture capacity in tons per annum CO 2}{N}$$

$$Z = \frac{X}{\sqrt{Y}}$$

As discussed above, an advantage of the disclosed subject matter is the improved CO₂ capture capacity of the DAC array in a process according to the present invention. In an embodiment, the process may have a CO₂ capture capacity of more than 500,000 tons CO₂ per annum and a productivity between 50 and 400 tons of CO₂ captured per square kilometer per hour. In another embodiment, the process may have a CO₂ capture capacity of between 100,000- and 500,000-tons CO₂ per annum and a productivity above 400 tons of CO₂ captured per square kilometer per hour.

For the purposes of promoting an understanding of the principles of the invention, reference will now be made to the embodiments illustrated in the accompanying drawings, which are described in more detail below. The embodiments disclosed herein are not intended to be exhaustive or limit the invention to the precise form disclosed in the following detailed description. The invention includes any alterations and further modifications in the illustrated devices and described methods and further applications of the principles of the invention as set forth in the claims.

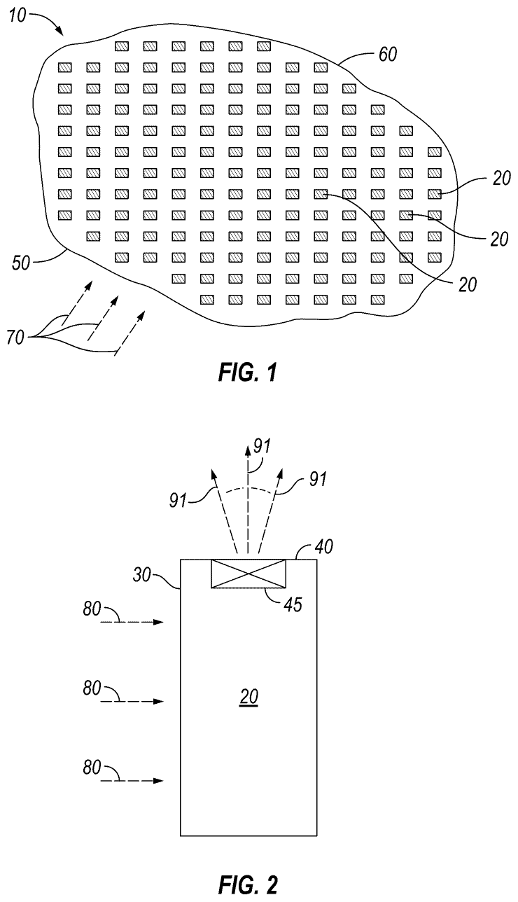

FIG. 1 shows a top view of a large scale direct air capture array according to an implementation of the disclosed subject matter. FIG. 1 shows an example of a large scale direct air capture array 10 viewed from above. As shown in FIG. 1, a method for operating a direct air capture process may include an array 10 comprising a plurality of DAC units 20. The DAC units 20 may be arranged in the array 10 having an overall array shape that is not a single line formation, as shown. The array 10 may have an upwind side 50 and a downwind side 60 dependent on a wind direction of a wind stream 70. The array 10 may receive, at the upwind side 50 of the array 10, the wind stream 70 having a wind speed of 1.0 m/s or more.

FIG. 2 shows a side view of a DAC unit according to an implementation of the disclosed subject matter. As shown in FIG. 2, a DAC unit 20 may have at least one side inlet face 30, and an outlet 40 located at the top of the DAC unit 20. An air feed stream 80 may be received at the side inlet face 30 and the air feed stream 80 may have an average CO₂ concentration of at least 300 ppmv for all atmospheric stability conditions. A CO₂ depleted outlet stream 90 having a flow may be provided at the outlet 40. The flow may be generated by a device for increasing kinetic energy 45 of the CO₂ depleted outlet stream 90. Further, the flow of the CO₂ depleted outlet stream 90 may have a flow direction 91 that may be within +/−20° of vertical. According to an embodiment, the CO₂ depleted outlet stream may have a velocity between 5 and 15 m/s.

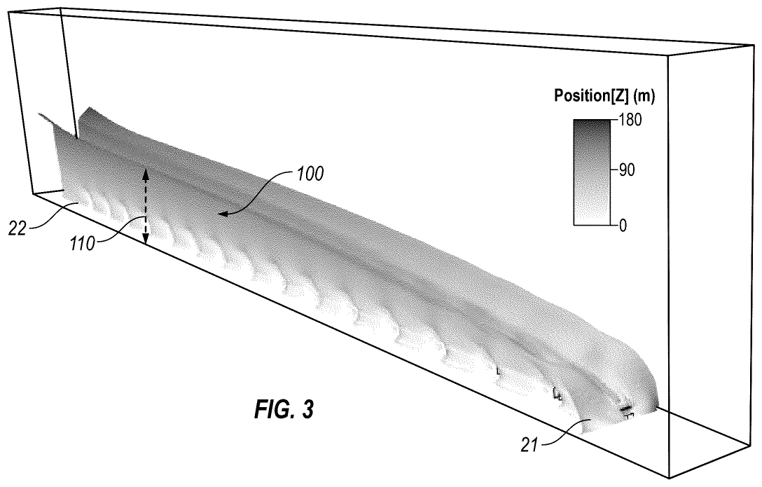

FIG. 3 shows a contour map of bulk air mixing zones increasing in the downwind direction across the array according to an implementation of the disclosed subject matter. As shown in FIG. 3, a recirculation zone 100 may be generated by a subset of DAC units 20, 21 within the array. The subset may include a combination of DAC units located between the upwind and downwind side of the array. For example, as shown in FIG. 3, a DAC unit 21 may be located at the upwind side of the array and a DAC unit 22 may be located at the downwind side of the array. The recirculation zone 100 may have a height H 110 created by the cumulative action of the devices (not shown in FIG. 3) for increasing kinetic energy located at the tops of the DAC units 21, 22. Also shown, the height H 110 may increase (as indicated by increasing shading from lighter to darker in the contour map) in the downwind direction between the DAC unit 21 at the upwind side of the array towards the DAC unit 22 located at the downwind side of the array. In an embodiment, the height H 110 may be at least 100 meters at the DAC unit 22 located at the downwind side of the array within the subset.

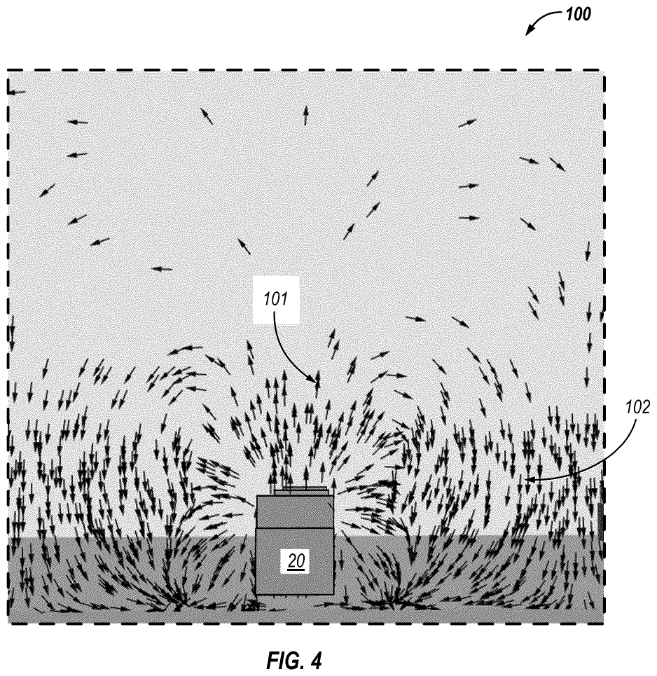

FIG. 4 shows a side view of an example air flow directions within a recirculation zone surrounding a DAC unit according to an implementation of the disclosed subject matter. As shown in FIG. 4, a recirculation zone 100 surrounding a DAC unit 20 may have an inner section 101, an outer section 102, and a recirculation flow as depicted by the directional arrows. As shown, the recirculation flow within the inner section 101 may be upward in direction as depicted by the arrows and the recirculation flow within the outer section 102 may be downward in direction as depicted by the arrows.

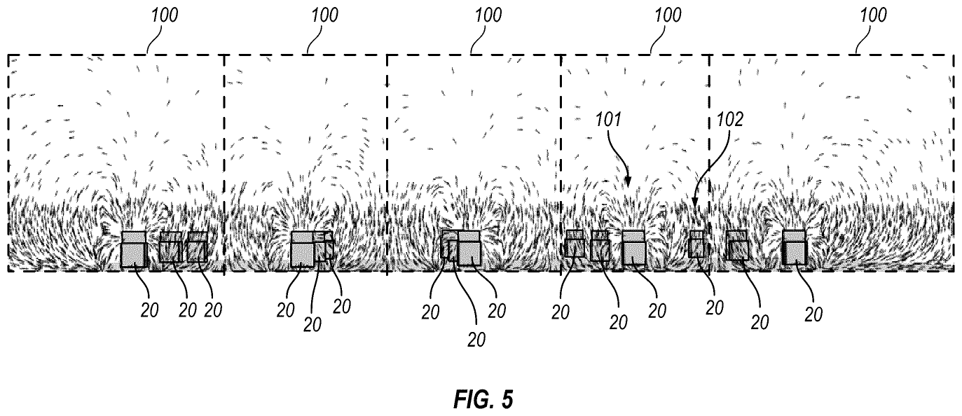

FIG. 5 shows a side view of an example air flow directions within a plurality of recirculation zones surrounding a plurality of DAC units according to an implementation of the disclosed subject matter. As shown in FIG. 5, a plurality of recirculation zones 100 may be generated by a plurality of DAC units 20. Each of the recirculation zones 100 may have an inner section 101, an outer section 102, and a recirculation flow as depicted by the directional arrows. As shown, the recirculation flow within the inner section 101 may be upward in direction as depicted by the arrows and the recirculation flow within the outer section 102 may be downward in direction as depicted by the arrows. As shown in FIG. 5, each recirculation zone 100 may be generated by a subset of DAC units 20 within the array. The subset may include a combination of DAC units located between the upwind and downwind side of the array.

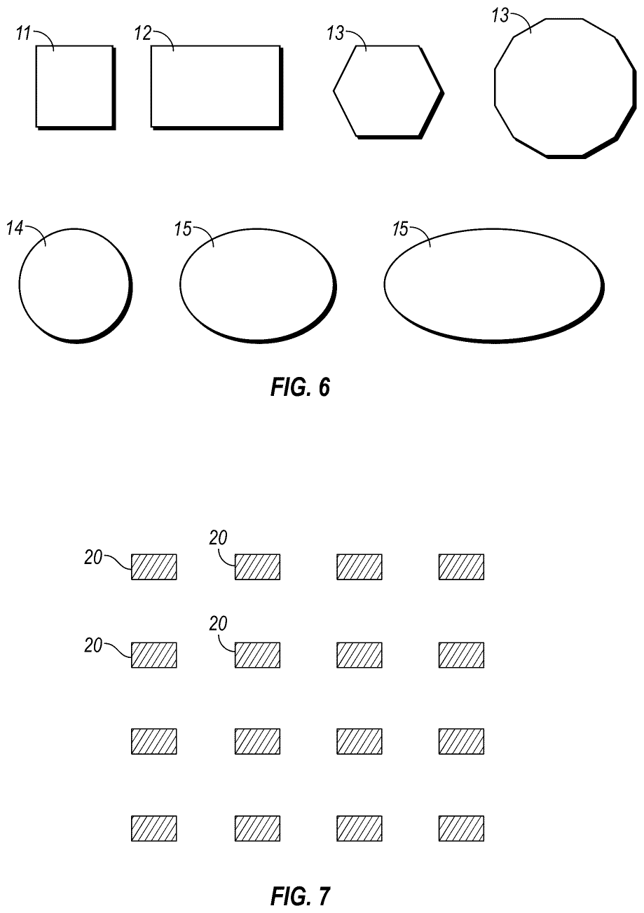

FIG. 6 shows a top view of examples of polygonal and ellipsoidal array shapes according to an implementation of the disclosed subject matter. As shown in FIG. 6, the array may have an overall array shape of a polygonal or ellipsoidal form. FIG. 6 shows examples of these various polygonal and ellipsoidal forms. As shown, an overall array shape may be square 11, rectangular 12, other polygons 13, circle 14 and ellipses 15.

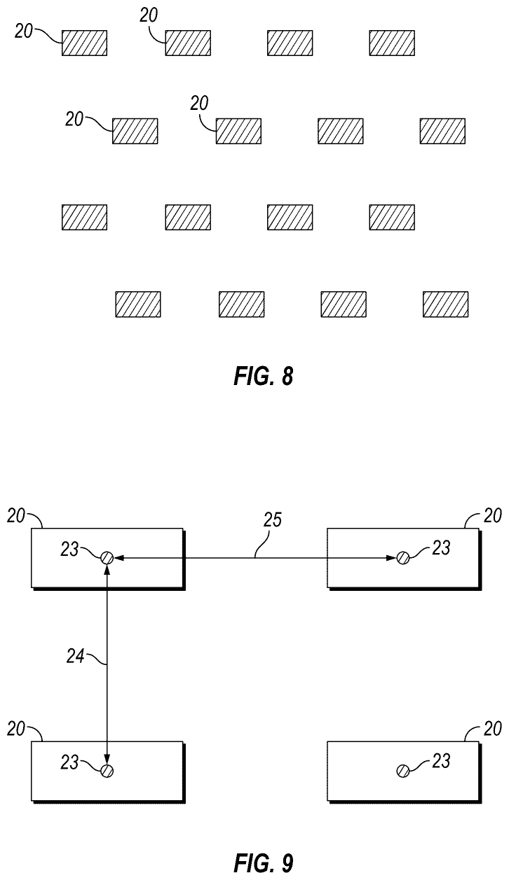

Further, the method for operating a direct air capture process according to an implementation of the disclosed subject matter, the DAC units within the array are arranged in an orthogonal or diagonal pattern. FIGS. 7 and 8 show examples of orthogonal and hexagonal patters. FIG. 7 shows a top view of an example orthogonal arrangement of DAC units 20 within an array according to an implementation of the disclosed subject matter. FIG. 8 shows a top view of an example diagonal arrangement of DAC units within an array according to an implementation of the disclosed subject matter.

FIG. 9 shows a top view of the average distance X between the centers of adjacent DAC units according to an implementation of the disclosed subject matter. According to an implementation, each DAC unit may have a center point, and the DAC units may be arranged with a spacing X, where X may be the average distance between the center points of each of the DAC units. As shown in FIG. 9, for example, 24 may be the distance between the centers 23 of adjacent DAC units 20 in one axis, viewed from above. As another example, 25 may be the distance between the centers 23 of adjacent DAC units 20 in another axis, viewed from above. In this case, X may be the average of the distances 24 and 25.

For the purposes of promoting an understanding of the principles of the invention, reference will now be made to the Examples carried out of various embodiments of the present invention, which are described in more detail below. The Examples and embodiments disclosed herein are not intended to be exhaustive or limit the invention to the precise form disclosed in the following Examples. The invention includes any alterations and further modifications in the provided Examples and described methods and further applications of the principles of the invention as set forth in the claims.

### Examples

The following Examples are based on modeling performed for a DAC array process including 256 DAC units, arranged orthogonally. Examples 1-3 included recirculation zones according to implementation of the disclose subject matter while Comparative Examples 1-3 did not include recirculation zones. Other variables were adjusted in each Example as described below.

Comparative Example 1—The CO₂ concentration at the downwind side of a DAC array was calculated. The array was a square array of 16 by 16, total 256 DAC units, arranged orthogonally. The distance X between the centers of DAC units was 90 meters. The process had a CO₂ capture capacity of 932,000 tons CO₂ per annum and a productivity of 64 tons of CO₂ captured per square kilometer per hour. A wind stream with a wind speed of 5 meters per second was orthogonal to the upwind side of the array. Atmospheric conditions were neutral, resulting in a vertical dispersion coefficient of 40 m at the downwind side of the array. There were no recirculation zones set up by subsets of DAC units in the array. The average CO₂ concentration at the downwind side of the array was calculated to be 269 ppmv.

Example 1—The CO₂ concentration at the downwind side of a DAC array was calculated. The array was a square array of 16 by 16, total 256 DAC units, arranged orthogonally. The distance X between the centers of DAC units was 90 meters. The process had a CO₂ capture capacity of 932,000 tons CO₂ per annum and a productivity of 64 tons of CO₂ captured per square kilometer per hour. Each DAC unit had two side inlet faces and a top outlet. A wind stream with a wind speed of 5 meters per second was orthogonal to the upwind side of the array. A commercially available, multi-physics modeling software StarCCM+ was used to compute the fluid flow patterns and carbon dioxide concentration profiles for the air flow in the DAC array, between the upwind and downwind sides of the array. There were 16 recirculation zones, each with a height of 180 m at the downwind side of the array. The average CO₂ concentration at the downwind side of the array was calculated to be 390 ppmv.

Comparison of the results of Comparative Example 1 and Example 1 shows an advantage of the invention. In Comparative Example 1, CO₂ concentration at the downwind side of the array was only 269 ppmv, as compared to 390 ppmv in Example 1 according to the present invention. This lower CO₂ concentration in Comparative Example 1 would require processing larger volumes of air and the requirement of more sorbent area, as compared to the Example 1 according to the present invention.

Comparative Example 2—The CO₂ concentration at the downwind side of a DAC array was calculated. The array was a square array of 16 by 16, total 256 DAC units, arranged orthogonally. The distance X between the centers of DAC units was 45 meters. The process had a CO₂ capture capacity of 932,000 tons CO₂ per annum and a productivity of 256 tons of CO₂ captured per square kilometer per hour. A wind stream with a wind speed of 5 meters per second was orthogonal to the upwind side of the array. Atmospheric conditions were neutral, resulting in a vertical dispersion coefficient of 30 m at the downwind side of the array. There were no recirculation zones set up by subsets of DAC units in the array. The average CO₂ concentration at the downwind side of the array was calculated to be 51 ppmv.

Example 2—The CO₂ concentration at the downwind side of a DAC array was calculated. The array was a square array of 16 by 16, total 256 DAC units, arranged orthogonally. The distance X between the centers of DAC units was 45 meters. The process had a CO₂ capture capacity of 932,000 tons CO₂ per annum and a productivity of 256 tons of CO₂ captured per square kilometer per hour. Each DAC unit had two side inlet faces and a top outlet. A wind stream with a wind speed of 5 meters per second was orthogonal to the upwind side of the array. A commercially available, multi-physics modeling software StarCCM+ was used to compute the fluid flow patterns and carbon dioxide concentration profiles for the air flow in the DAC array, between the upwind and downwind sides of the array. There were 16 recirculation zones, each with a height of 100 m at the downwind side of the array. The average CO₂ concentration at the downwind side of the array was calculated to be 335 ppmv.

Comparison of the results of Comparative Example 2 and Example 2 shows an advantage of the invention. In Comparative Example 2, CO₂ concentration at the downwind side of the array was only 51 ppmv, as compared to 335 ppmv in Example 2 according to the present invention. This lower CO₂ concentration in Comparative Example 2 would require processing much larger volumes of air and the provision of much more sorbent area, compared to the Example of the invention.

Comparative Example 3—The CO₂ concentration at the downwind side of a DAC array was calculated. The array was a square array of 16 by 16, total 256 DAC units, arranged orthogonally. The distance X between the centers of DAC units was 90 meters. The process had a target CO₂ capture capacity of 932,000 tons CO₂ per annum and a target productivity of 64 tons of CO₂ captured per square kilometer per hour. A wind stream with a wind speed of 1 meters per second was orthogonal to the upwind side of the array. Atmospheric conditions were neutral, resulting in a vertical dispersion coefficient of 40 m at the downwind side of the array. There were no recirculation zones set up by subsets of DAC units in the array. The calculated average CO₂ concentration in the array reached zero before the wind reached the downwind side of the array, which means that target capacity and productivity could not be achieved in Comparative Example 3.

Example 3—The CO₂ concentration at the downwind side of a DAC array was calculated. The array was a square array of 16 by 16, total 256 DAC units, arranged orthogonally. The distance X between the centers of DAC units was 90 meters. The process had a CO₂ capture capacity of 932,000 tons CO₂ per annum and a productivity of 64 tons of CO₂ captured per square kilometer per hour. Each DAC unit had two side inlet faces and a top outlet. A wind stream with a wind speed of 1 meters per second was orthogonal to the upwind side of the array. A commercially available, multi-physics modeling software StarCCM+ was used to compute the fluid flow patterns and carbon dioxide concentration profiles for the air flow in the DAC array, between the upwind and downwind sides of the array. There were 16 recirculation zones, each with a height of 160 m at the downwind side of the array. The average CO₂ concentration at the downwind side of the array was calculated to be 345 ppmv.

Comparison of the results of Comparative Example 3 and Example 3 shows an advantage of the invention. In Comparative Example 3, CO₂ is fully depleted before the wind reached the downwind side of the array, this means that target capacity and productivity could not be achieved in Comparative Example 3. In contrast, in Example 3, according to the present invention, the average CO₂ concentration at the downwind side of the array was calculated to be 345 ppmv.

TABLE 2
Summary of Results from Examples and Comparative Examples

| | | | | | | | Productivity | | |
|---|---|---|---|---|---|---|---|---|---|
| | | | | | | | (tons CO₂ | CO₂ | Height H |
| | | | | | | | captured | concentration | at |
| | | | Wind | # of | | CO₂ capture | per square | at downwind | downwind |
| | Array | | speed | DAC | Distance | capacity (tons | kilometer | side of the | side of the |
| Ex. # | shape | Wind direction | (m/s) | units | X (m) | per annum) | per hour) | array (ppmv) | array (m) |
| Comp. | Square | Orthogonal to | 5 | 256 | 90 | 932,000 | 64 | 269 | — |
| Ex. 1 | | upwind side of | | | | | | | |
| | | the array | | | | | | | |
| Ex. 1 | Square | Orthogonal to | 5 | 256 | 90 | 932,000 | 64 | 390 | 180 |
| | | upwind side of | | | | | | | |
| | | the array | | | | | | | |
| Comp. | Square | Orthogonal to | 5 | 256 | 45 | 932,000 | 256 | 51 | — |
| Ex. 2 | | upwind side of | | | | | | | |
| | | the array | | | | | | | |
| Ex. 2 | Square | Orthogonal to | 5 | 256 | 45 | 932,000 | 256 | 335 | 100 |
| | | upwind side of | | | | | | | |
| | | the array | | | | | | | |
| Comp. | Square | Orthogonal to | 1 | 256 | 90 | 932,000 | 64 | 0 (see note 1) | — |
| Ex. 3 | | upwind side of | | | | | | | |
| | | the array | | | | | | | |
| Ex. 3 | Square | Orthogonal to | 1 | 256 | 90 | 932,000 | 64 | 345 | 160 |
| | | upwind side of | | | | | | | |
| | | the array | | | | | | | |

Note 1:
CO2 exhausted before the downwind side of the array was reached.

As shown in Table 2 above, the present invention achieves a CO₂ concentration at the downwind side of the array of at least 300 ppmv. Specifically, the CO₂ concentration at the downwind side of the array was 390 ppmv in Example 1, 335 ppmv in Example 2, and 345 ppmv in Example 3. On the other hand, none of the comparative examples achieved a CO₂ concentration at the downwind side of the array of at least 300 ppmv. Specifically, the CO₂ concentration at the downwind side of the array was 269 ppmv in Comparative Example 1, 51 ppmv in Comparative Example 2, and 0 ppmv in Comparative Example 3. These lower CO₂ concentration as in Comparative Examples 1-3 will require processing much larger volumes of air and larger sorbent area, as compared to the Example of the present invention. Furthermore, the DAC process according to the present invention and including recirculation zones allows for optimized array dimensions and thereby reduced costs in the overall DAC process. Moreover, the disclosed subject matter allows for a DAC array to occupy less land area, while still meeting target productivity for all wind directions, wind speeds and atmospheric stability conditions.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method for operating a direct air capture process, the process comprising:
a) an array comprising a plurality of direct air capture (DAC) units, each DAC unit comprising:
i. at least one side inlet face, and
ii. an outlet located at the top of the DAC unit;
wherein the DAC units are arranged in the array having an overall array shape that is not a single line formation, and wherein the array has an upwind side and a downwind side dependent on a wind direction of a wind stream in the surrounding atmosphere;
b) receiving, at the upwind side of the array, the wind stream having a wind speed of 1.0 m/s or more;
c) receiving an air feed stream at the plurality of side inlet faces wherein the air feed stream has an average CO₂ concentration of at least 300 ppmv for all atmospheric stability conditions;
d) providing, at each of the outlets, a CO₂ depleted outlet stream having a flow, wherein the flow is generated by a device for increasing kinetic energy of the CO₂ depleted outlet stream;
e) generating a plurality of recirculation zones, each recirculation zone being generated by a subset of DAC units within the array, the subset including a combination of DAC units located between the upwind and downwind sides of the array, and wherein each recirculation zone has an inner section, an outer section, and a recirculation flow.

2. The method for operating a direct air capture process according to claim 1, wherein the flow of the CO₂ depleted outlet stream has a flow direction that is within 20° of vertical.

3. The method for operating a direct air capture process according to claim 1, wherein the recirculation flow within the inner section is upward in direction,
wherein the recirculation flow within the outer section is downward in direction, and wherein each recirculation zone has a height H.

4. The method for operating a direct air capture process according to claim 1, wherein the array has an overall array shape of a polygonal or ellipsoidal form.

5. The method for operating a direct air capture process according to claim 1, wherein the DAC units within the array are arranged in an orthogonal or diagonal pattern.

6. The method for operating a direct air capture process according to claim 1, wherein each DAC unit has a center point, and the DAC units are arranged with a spacing X, wherein X is the average distance between the center points of each of the DAC units.

7. The method for operating a direct air capture process according to claim 1, wherein the process has a CO₂ capture capacity of more than 500,000 tons CO₂ per annum and a productivity between 50 and 400 tons of CO₂ captured per square kilometer per hour.

8. The method for operating a direct air capture process according to claim 1, wherein the process has a CO₂ capture capacity of between 100,000 and 500,000 tons CO₂ per annum and a productivity above 400 tons of CO₂ captured per square kilometer per hour.

9. The method for operating a direct air capture process according to claim 3, wherein the height H of the recirculation zone increases towards the downwind side within the subset of DAC units, and wherein the height H is at least 100 meters at the DAC unit located at the downwind side of the array within the subset.

10. The method for operating a direct air capture process according to claim 1, wherein the CO₂ depleted outlet stream has a velocity between 5 and 15 m/s.

11. The method for operating a direct air capture process according to claim 6, wherein the array comprises N number of DAC units, wherein;
$$W herein ; Y = \frac{Capture capacity in tons per annum CO 2}{N}$$
$$Z = \frac{X}{\sqrt{Y}}$$
and wherein Z is between 0.5 and 2.0.
